(19) United States
(12) Patent Application Publication
(10) Pub. No.: US 2025/0139262 A1
(43) Pub. Date: May 1, 2025

(54) ACCESS CONTROL FOR COMPUTING RESOURCES

(71) Applicant: DMG Blockchain Solutions Inc., Delta (CA)

(72) Inventors: Daniel Marks, Durham, NC (US); Joshua Metnick, Chicago, IL (US); David Steinberg, Chicago, IL (US); Richard Adjei, Scarsdale, NY (US); Eric William Price, Miami Beach, FL (US); Robert Maciej Pieta, Glenview, IL (US); John Finley Detjen, Winnetka, IL (US)

(21) Appl. No.: 18/936,479

(22) Filed: Nov. 4, 2024

Related U.S. Application Data
(63) Continuation of application No. PCT/US2023/020630, filed on May 1, 2023.
(60) Provisional application No. 63/337,541, filed on May 2, 2022.

(51) Int. Cl. G06F 21/62; G06F 21/60

(52) U.S. Cl. CPC G06F 21/62; G06F 21/602

(57) ABSTRACT

Machines and articles, processes for using the machines and articles, processes for making the machines and articles, and products produced by the processes of making, along with necessary intermediates, involving aspects of authorizing access to computing resources using non-fungible tokens.

### CROSS-REFERENCE TO RELATED APPLICATION(S)

This application claims priority to and is a 35 U.S.C. § 111 (a) continuation of, PCT international application number PCT/US2023/020630 filed on May 1, 2023, incorporated herein by reference in its entirety, which claims priority to, and the benefit of U.S. Provisional Patent Application No. 63/337,541, filed on May 2, 2022, incorporated herein by reference in its entirety. Priority is claimed to each of the foregoing applications.

### TECHNICAL FIELD

Industrial applicability is representatively directed to that of apparatuses and devices, articles of manufacture, and processes of making and using them as disclosed herein. Industrial applicability also includes industries engaged in such as one or more of computer science and electrical engineering, field programmable gate arrays, application specific integrated circuits, cryptography, central processing units, memory such as random access memory, nonvolatile memory, and rotating media storage or solid state flash memory storage, networking, communications and/or telecommunications, and computing systems, e.g., those involving a bank of computers, with or without a director computer, as well as industries operating in cooperation therewith, depending on the implementation.

### BACKGROUND

Previously, U.S. Pat. Ap. No. 20210326862 disclosed a method and apparatus for managing digital items may be implemented using a distributed ledger and smart contracts associated therewith. Users may interact with a smart contract to generate, manage ownership and transfer digital items of various kinds. The digital items are defined by characteristics particular to each implementation of the system. Some values for the characteristics may be less likely to occur relative to other values for those characteristics, thus generating some rare digital items and more common digital items. Digital items may correspond to a real-world item or may only exist virtually. A smart contract may also be used to convert the digital items to real-world physical items.

U.S. Pat. Ap. No. 20220101316 includes a disclosure that involves a method for grouping non-fungible digital tokens. The method includes generating a first transaction on a blockchain having an output of a fungible digital token, with the fungible digital token having a first transaction hash identifier. The method further includes assigning the first transaction hash identifier associated with the fungible digital token with a cryptographic public key, and generating a second transaction on the blockchain having an output of a non-fungible digital token and an input. The fungible digital token is spent as the input into the second transaction, with the non-fungible digital token comprising a second transaction hash identifier and a group identifier associated with the first transaction hash identifier.

Also, U.S. Pat. Ap. No. 20220108027 mentions a system includes a memory device and a processor, operatively coupled with the memory device, to perform operations including receiving, from a device via a brokering agent, a request to provide an encrypted version of a set of secrets data corresponding to a target state of the device, determining whether to authorize the request in view of the brokering agent, and in response to authorizing the request, providing the encrypted version of the set of secrets data and permission to transition to the target state.

Other previous endeavors include boredapeyachtclub.com, which may be a collection of unique non-fungible tokens, where each non-fungible token points to a digital asset of an ape face image. Similarly, nbatopshot.com may have non-fungible tokens as a set of non-fungible tokens created by Dapper Labs using the Flow Non-Fungible Token Standard. The non-fungible token contains a group of collectibles. Likewise, themetakey.com may involve a non-fungible token that, according to its website, is used to grant access to a metaverse to a possessor of a non-fungible token. Further, OpenID nft-login project, e.g., https://github.com/nft-login/nft-login, may involve a non-fungible token that is used to provide access to a computer to a possessor of a non-fungible token.

In view of such as the foregoing, a need exists for other or better alternatives.

### SUMMARY

This Summary is provided to introduce the idea herein that a selection of concepts is presented in a simplified form as further described below. This Summary is not intended to identify key features or essential features of subject matter, nor this Summary intended to be used to limit the scope of claimed subject matter. Additional aspects, features, and/or advantages of examples will be indicated in part in the description which follows and, in part, will be apparent from the description, or may be learned by practice of the disclosure.

The following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

With the foregoing in mind, consider apparatuses and articles of manufacture, processes for using the apparatuses and articles, processes for making the apparatuses and articles, and products produced by the processes of making, along with necessary intermediates, in the context that some, but not all, embodiments concern, in whole or part, a bank of computers providing computing resources and configured to perform tasks, each one of said tasks associated with a list comprising a portion of the computing resources needed to carry out the associated one of said tasks, computer means for determining whether an instruction is signed by a cryptographic key such that if the instruction is signed by the cryptographic key, compare a list with a list of authorized computing resources to determine whether the portion of the computing resources is sufficient to perform the associated one of said tasks, and if the portion of the computing resources is sufficient, cause the associated one of said tasks to be performed on the bank of computers; and if the instruction is not signed or if the portion of the computing resources is not sufficient, then do not cause the associated one of said tasks to be performed.

From another perspective, there can be a method of making the apparatus, including interconnecting a computer means for determining whether an instruction is signed by a cryptographic key with a bank of computers, the interconnecting carried out after programming the bank of computers to provide computing resources to perform tasks, each one of said tasks associated with a list comprising a portion of the computing resources needed to carry out the associated one of said tasks, and after programming the computer means for determining whether an instruction is signed by a cryptographic key and: if the instruction is signed by the cryptographic key, compare the list with the list of authorized computing resources to determine whether the portion of the computing resources is sufficient to perform the associated one of said tasks, and if the portion of the computing resources is sufficient, cause the associated one of said tasks to be performed on the bank of computers, and if the instruction is not signed or if the portion of the computing resources is not sufficient, then do not cause the associated one of said tasks to be performed.

In another way of thinking, there can be a method of using the apparatus of claim, the method including: controlling a computer means for determining whether an instruction is signed by a cryptographic key with a bank of computers arranged to provide computing resources and configured to perform tasks, each one of said tasks associated with a list comprising a portion of the computing resources needed to carry out the associated one of said tasks, and: if the instruction is signed by the cryptographic key, compare the list with the list of authorized computing resources to determine whether the portion of the computing resources is sufficient to perform the associated one of said tasks, and if the portion of the computing resources is sufficient, cause the associated one of said tasks to be performed on the bank of computers, and if the instruction is not signed or if the portion of the computing resources is not sufficient, then do not cause the associated one of said tasks to be performed.

### BRIEF DESCRIPTION OF THE DRAWINGS

FIG. 1 is an illustration of an embodiment.

FIGS. 2A and 2B are illustrations of embodiments of the bank of computers.

FIGS. 3A and 3B are illustrations of embodiments of lists of authorized computing resources.

FIG. 4 is an illustration of embodiments of adding transactions to a distributed ledger.

FIG. 5 is an illustration of embodiments of authentication of an instruction.

FIG. 6 is an illustration of embodiments of a list comprising a portion of the resources needed to carry out the associated one of said tasks.

FIG. 7 is an illustration of embodiments of a pointer to a list of authorized computing resources.

FIG. 8 is an illustration of embodiments of a non-fungible token.

### DETAILED DESCRIPTION

Authorization of access to computing resources is typically based on identity. This identity may be established by demonstrating that one possesses a secret associated with the identity such as a secret password or a secret key, or by presenting a physical object associated with the identity such as a hardware encryption device or a biometric signature. There is a step of associating the identity with a secret or a physical object which requires an identity to be established. In some cases, it may not be desirable to authorize access to computer resources based on an identity and so obviate the need to establish an identity. Rather, demonstrating that one possesses a token may be sufficient to authorize access to computer resources. The token could be transferred between parties with the party currently possessing the token being authorized access to the computing resources. This may offer a degree of convenience to a provider of computing resources, because the provider would know that a party demonstrating the possession of a token obtained the token from another party who possessed the token and so already was authorized to access the computing resources. This is similar to how a physical key works, where the physical key is an object used to open a lock with the identity of the keyholder being irrelevant. Similarly, it can provide convenience to a user of computing resources, as it would allow easy transfer of the access to computing resources by a token to another user.

In many organizations, most keys are unable to unlock every lock, and keys are issued to keyholders based on which locks the keyholder is permitted to unlock. Similarly, it may be desirable to limit the access of a party possessing a token to particular computing resources. A physical key may typically have features on it such as ridges or notches which engage pins in the lock mechanism so that a lock is unlocked by a key with the correct combination of features. Similarly, it is desirable for a token to have features that determine the access of a party possessing the token to particular computing resources. A non-fungible token (NFT) may be used to implement such a token. A NFT is a unique token that may be transferred from one account to another typically with the transactions regarding the NFT recorded in a distributed ledger. The records of the distributed ledger may be examined to determine the sequence of transactions regarding the NFT as to determine the account currently possessing the NFT. The parties conducting a transfer may be known only by their account information and may not otherwise be identifiable. While an account may not be identifiable as a particular person or organization, an account typically has an associated secret cryptographic key with which the account holder authorizes transactions regarding the account. To authenticate a message that requires proof of possession of a NFT, a signature on the message is verified as being signed by a particular secret key, and it is verified that the secret key corresponds to the account of the possessor of the NFT as recorded by the sequence of transactions on the distributed ledger.

A NFT, as well as being an entity that one may demonstrate possession of, can also include information. A NFT is commonly implemented by a smart contract, with the smart contract being a program that determines the permitted operations of a NFT. For example, a smart contract may determine the permitted conditions for which the NFT may be transferred, or the contents of any information included in the NFT. The information included in the NFT is in the record of the NFT in the distributed ledger. When a message requiring proof of possession of the NFT is authenticated, the information included with the NFT present in the record in the distributed ledger can be used to determine in part the authorized computer resources. The information included in the NFT is analogous to the features on a key which determine the locks that may be opened by the key. The information that is included in the NFT may be stored independently of any computers or networks that provide computing resources, and so may continue to exist independently of any particular computer or network that provides computing resources. The NFT may then be used to authorize access to computing resources on a distributed network of computers without requiring that any identity or access credentials be stored on the distributed network of computers.

An overview of the construction and usage of an embodiment is provided. A bank of computers may be configured to perform useful functions or tasks. For example, these useful functions or tasks include cryptocurrency mining, combinatorial optimization problems, scientific or financial computations, solving complex optimization problems such as in biophysics and bioinformatics, cloud computing, and distributed software development. In order to perform a particular task, certain computing resources or a certain amount of computing resources are required on the bank of computers. For example, computing resources may include a type of central processing unit (CPU) such as Intel or AMD or ARM CPU with particular capabilities, an amount of random access memory, an amount of hard disk storage or solid state storage, and specialized computing units such as field programmable gate arrays, particular application specific integrated circuits, and graphics processing units such as those produced by NVIDIA and AMD. An administrator of the bank of computers may desire to limit the amount of computing resources that a task may use, for example, to keep computing resources available for other tasks. Alternatively, an administrator may desire to limit the computing resources available to a task to particular computers or to particular hardware or software. An administrator may then create a non-fungible token that includes a description of the computing resources that the possessor of the non-fungible token is authorized to use.

When a possessor of the non-fungible token wishes to have the bank of computers perform a task, the possessor sends an instruction to perform the task to a director computer that may cause the bank of computers to perform tasks. The director computer controls access to the computing resources of the bank of computers by determining which tasks are performed on the bank of computers. The instruction is cryptographically signed by the possessor of the non-fungible token so it can be verified by the director computer that the instruction was created by the possessor of the non-fungible token. This instruction usually includes the identity of the non-fungible token and the identity of the task that the possessor of the non-fungible token requests the director computer to have performed on the bank of computers. For example, the task may be to mine cryptocurrency or to execute a virtual machine containing a scientific simulation program. The instruction may also include a list of the computing resources needed to perform the task. The director computer checks the distributed ledger and determines the possessor of the non-fungible token, and then checks to see if the signature on the instruction is that of the possessor. If these checks confirm that the instruction is indeed signed by the possessor of the non-fungible token, then the director computer compares the list of the computing resources needed to perform the task to the computing resources that are authorized by the non-fungible token. If the authorized computing resources have a greater capacity or capability than all of the items on the list of computing resources needed to perform the task, for example, if a hash rate that is authorized is greater than or equal to a hash rate that is needed, or if an amount memory that is authorized is greater than or equal to an amount of memory that is needed, or the capabilities of a central processing unit that is authorized are greater than or equal to the capabilities of a central processing unit that is needed, then the authorized computing resources are sufficient to perform the task. If the instruction is signed by the possessor of the non-fungible token and the authorized computing resources are sufficient, the director computer then causes the bank of computers to perform the task, typically by instructing the bank of computers to perform the task. If the director computer does not find a valid signature of the possessor on the instruction, or finds that some or all of the authorized computing resources are insufficient for performing the task, the director computer does not cause the bank of computers to perform the task.

The bank of computers may be constructed from general purpose computer hardware that is common to server clusters, for example, rack mounted servers with Intel, AMD, or ARM central processing units, gigabytes of dynamic RAM, one or more network interfaces such as gigabit ethernet, solid state disk storage, rotating media storage, and other specialized hardware such as graphics processing units, field programmable gate arrays, and application specific integrated circuits. More specialized computers may be present in the bank of computers such as cryptocurrency miners. A director computer may also be constructed from general purpose computer hardware. Typically these may use an operating system such as Linux, FreeBSD, NetBSD, Windows, MacOS X, etc. A computer may have virtualization capabilities to facilitate executing a virtual machine. The bank of computers and the director computer are typically, but not necessarily, connected together using a local area network. A possessor of a token may also have a personal computer with which the instruction is composed to be transmitted to a director computer. The personal computer may have cryptocurrency wallet software and/or hardware as well as a web browser. The personal computer may have specialized client software installed to communicate with the director computer. The computer originating an instruction may transmit an instruction to the director computer over the Internet.

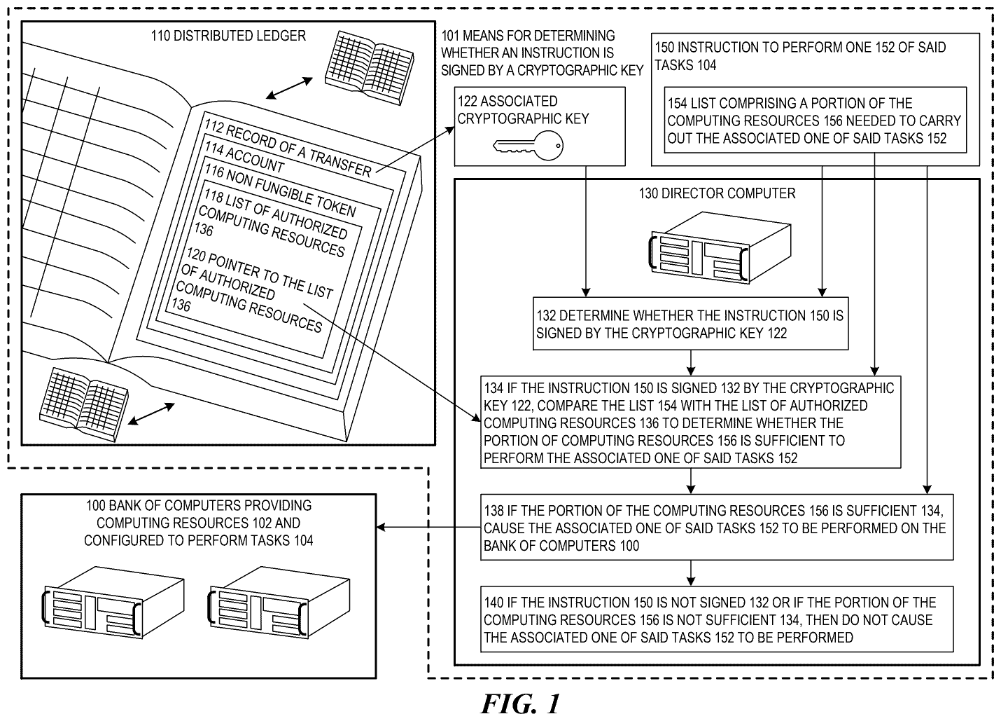

FIG. 1 is an illustration of an embodiment. For example, there can be an apparatus that includes a bank of computers, such as a bank of computers 100 providing computing resources 102 and configured to perform tasks 104. In some embodiments, each one of the tasks can be associated with a list that includes a portion of the computing resources needed to carry out the associated one of said tasks 104. In operable association with the bank of computers 100, there can be a computer means 101 for determining whether an instruction is signed by a cryptographic key such that if the instruction is signed by the cryptographic key, a list is compared with a list of authorized computing resources to determine whether the portion of the computing resources is sufficient to perform the associated one of said tasks, and if the portion of the computing resources is sufficient, cause the associated one of said tasks to be performed on the bank of computers, and if the instruction is not signed or if the portion of the computing resources is not sufficient, then do not cause the associated one of said tasks to be performed.

In another way of thinking, a bank of computers 100 provides computing resources 102 and is configured to perform tasks 104. A director computer 130 may cause tasks 104 to be performed on the bank of computers 100. By determining which tasks 104 are performed on the bank of computers 100, a director computer 130 may control access to the computing resources 102. In an embodiment, a director computer 130 may receive an instruction 150 to perform one 152 of said tasks 104. If the director computer 130 authorizes access to the computer resources 156 in response to the instruction 150, the director computer 130 causes the one task 152 to be performed. If the director computer 130 does not authorize access to the computer resources 156 in response to the instruction 150, the director computer 130 does not cause the one task 152 to be performed and may perform a predetermined action.

In an embodiment, a distributed ledger 110 may contain records. A record may be a record of a transfer 112 of a non-fungible token 116 to an account 114. A distributed ledger 110 may be implemented as a blockchain, and the blocks in the blockchain may contain one or more records. The blocks of a blockchain may form at least one of a directed acyclic graph or a Merkle tree, with a directed edge being oriented between a block towards another block that has been subsequently added to the blockchain. A director computer 130 may examine a distributed ledger 110 to identify a record of a transfer 112 of a non-fungible token 116 to an account 114 that was subsequently added after all other records of a transfer 112 of the non-fungible token 116 to determine the account 114 which the non-fungible token 116 was most recently transferred to. The account 114 which the non-fungible token 116 was most recently transferred to is the possessor of the non-fungible token 116. A first record of a transfer 112 may be determined to have been subsequently added after a second record of a transfer 112 by determining if the first record of a transfer 112 is contained within a block that was subsequently added to the blockchain after a block containing the second record of a transfer 112. If the first record of a transfer 112 and the second record of a transfer 112 are contained within the same block, the order of the records within the block may be examined to determine which of the records was subsequently added. The timestamps on two records of a transfer 112 or two blocks may be used to determine which was subsequently added after the other.

A record on the distributed ledger 110 may establish the existence of the non-fungible token 116 and establish its identity as distinct from any other tokens recorded in the distributed ledger 110. The record on the distributed ledger 110 that establishes the existence of the non-fungible token 116 may be a record of a transfer 112 of the non-fungible 116 from an account with an identity that is an invalid identifier of an account to an account 114 with a valid identifier. A subsequent transfer of the non-fungible token 116 between accounts, that may be recorded in the distributed ledger 110 as a record of a transfer 112 of the non-fungible token 116 to an account 114, maintains the identity of the non-fungible token 116 as distinct from any other tokens recorded in the distributed ledger 100. Furthermore, the identity of the non-fungible token 116 is maintained as distinct from other tokens, as a record may not be able to be added to the distributed ledger 110 that indicates the duplication of the non-fungible token 116 or the transfer of the identity of the non-fungible token 116 to another token. A record, including the record of a transfer 112 of a non-fungible token 116, may be implemented in part by a smart contract. A smart contract is a computer program which determines the permissible conditions for which a record may be added to a distributed ledger 110, and the actions required to add the record to the distributed ledger 110. When an attempt is made to add a record implemented in part by a smart contract to a distributed ledger 110, the computer program implementing the smart contract is executed to determine if the record satisfies the conditions for adding the record to the distributed ledger 110, and if the conditions are satisfied, performs the actions to add the record to the distributed ledger 110. A non-fungible token 116 may be implemented in part by a smart contract, where the smart contract may be implemented to only permit records of a transfer 112 of the non-fungible token 116 that maintain the identity of the non-fungible token 116 as distinct from any other tokens.

A record, for example a record that establishes or transfers 112 a non-fungible token 116, may also include other information. For example, if the record is implemented in part by a smart contract, the smart contract may also permit the creation of a record that includes the other information. The information may be arbitrary data. For example, the information may include text, a cryptographic hash, a content address, or a uniform resource identifier. A common blockchain for which smart contracts are created is the Ethereum blockchain and a smart contract on the Ethereum blockchain may be implemented using the Ethereum Virtual Machine. The Ethereum blockchain has standards for smart contracts including the ERC 721 “Non Fungible Token Standard” and the EIP 1155 “Multi Token Standard” which permit such information to be stored in the records containing smart contracts. This information can be retrieved from a record on the Ethereum blockchain of a smart contract implemented using these standards. This information is frequently used to store a pointer to the location of digital assets associated with the non-fungible token 116, such as a uniform resource identifier pointer, a content address pointer, or a cryptographic hash pointer. Often these digital assets are a graphics or bitmapped image. However, generally the pointer may point to any arbitrary data that may be stored in a computer file. The data which is pointed to may be used for the same purposes as the data in any computer file. Rather than using an existing smart contract standard, one may create an alternative smart contract that permits a record to contain additional information, as well as implements alternative permissible conditions for which a record may be added to the distributed ledger 110, and implements alternative actions to add a record to the distributed ledger 110.

Information that is included in a non-fungible token 116, or a pointer included in a non-fungible token 116 that points to information, may be useful for implementing a system to authorize access to computing resources 102. Information in a non-fungible token 116 may include a list of authorized computing resources 118. A pointer included in a non-fungible token 116 that points to information including authorized computing resources 136 may be a pointer to the list of authorized computing resources 120. The information in a non-fungible token 116 or pointed to by a pointer in a non-fungible token 116 may include a list of authorized computing resources 136. Authorized computing resources 136 may include a specification of one or more computing hardware items such as a computer processor, memory, network connectivity, application specific integrated circuits, or field programmable gate arrays, or a specification of software such an operating system, database software, numerical processing software, cryptocurrency mining software, a specification of a computational capability, capacity, hash rate, or other rate of computation, a specification of a time limit or time interval, etc.

A director computer 130 may receive an instruction 150 to perform one of said tasks 152. The director computer 130 may receive an instruction 150 over a computer network, for example, a local area network, a wide area network, a wireless network, or a combination of these. The director computer 130 may receive an instruction through a network socket, electronic mail, a text message, web server query, etc. The instruction 150 may be derived in part from a message that a user inputs into a computer program that can sign the message with the associated cryptographic key 122. The computer program may be a cryptocurrency wallet program or a program that maintains secret cryptocurrency authentication credentials, for example, MetaMask, Math Wallet, AlphaWallet, and Coinbase Wallet. The message, for example, may be a text message or JSON object indicating the instructions of the user with regards to the non-fungible token 116. For example, a text instruction 150 signed by a cryptographic key 122 may include a message that instructs the director computer 130 to cause 138 the bank of computers 100 to perform one of said tasks 152 to mine cryptocurrency. As an example, if the message was to instruct the director computer 130 to start mining cryptocurrency at a hash rate of 10 tera hashes per second between April 1 and Apr. 30 2022, the message that could be sent is “{instruction:” minebitcoin “, tokenid: <tokenid>, rate: 10000000000, pool: slushpool, wallet: <wallet address>, begintime: 20220401000000UTC, endtime: 20220430235959UTC}”, for example being in JSON format. The minebitcoin instruction portion of the instruction would instruct the director computer 130 to cause the bank of computers 100 to perform the one of said tasks that mines cryptocurrency, in this case, Bitcoin. The tokenid portion of the instruction 150 denotes the identifier of the non-fungible token 116 on the distributed ledger 100 so that the records of a transfer 112 of the non-fungible 116 token on the distributed ledger 100 may be identified by the director computer 130. The rate portion of the instruction 150 indicates the cryptographic hash rate at which the director computer 130 should cause 138 the bank of computers 100 to perform cryptographic hashes. In this case, the rate also is the 154 list comprising a portion of the computing resources 156 needed to carry out the associated one of said tasks 152. The pool portion of the instruction 150 indicates the identity of a cryptographic mining pool that the director computer 130 should cause 138 the bank of computers 100 to obtain work from when mining cryptocurrency. The wallet portion of the instruction 150 indicates the identity of the cryptocurrency wallet that the director computer 130 should cause 138 the bank of computers 100 to deposit the mined cryptocurrency into. The begintime portion of the instruction 150 indicates the time at which the director computer 130 should cause 138 the bank of computers 100 to start performing the one of said tasks 152, in this case, the cryptocurrency mining task. The endtime portion of the instruction 150 indicates the time at which the director computer 130 should cause 138 the bank of computers 100 to cease performing the one of said tasks 152, in this case, the cryptocurrency mining task. The times in this example are given in universal coordinated time (UTC).

In an alternative but not exclusive embodiment, an instruction 150 signed by a cryptographic key 122 may include a message that instructs the director computer 130 to cause 128 one or more computers of the bank of computers 100 to perform one of said tasks 152 that executes a virtual machine or container. As an example, if the message was to instruct the director computer 130 to execute a virtual machine for twenty-four hours on Apr. 1 2022, the message that could be sent is “{instruction:′executevm”, tokenid:<tokenid>, vmuri:<vmuri>, resources:cpus=3,cputype=×64,fpga=virtex7,asic=sha2,ram=128gb, nvm=2tb begintime: 2022040101000000UTC, endtime: 2022040101235959 UTC} ”, for example being in JSON format. The executevm instruction portion of the instruction would instruct the director computer 130 to cause 138 the bank of computers 100 to perform the one of said tasks that executes a virtual machine. The tokenid portion of the instruction 150 denotes the identifier of the non-fungible token 116 on the distributed ledger 100 so that the records of a transfer 112 of the non-fungible 116 token on the distributed ledger 100 may be identified by the director computer 130. The vmuri portion of the instruction contains the uniform resource identifier that the virtual machine data may be retrieved from, for example, as VirtualBox, VMWare, Xen, or KVM virtual machine data. The virtual machine data used to perform the one of said tasks 152 that executes a virtual machine may be retrieved by the director computer 130 or the bank of computers 100 from the location denoted by the uniform resource identifier, using any method of retrieval that may be required to retrieve data from a uniform resource identifier, for example hypertext transfer protocol (http), secure hypertext transfer protocol (https), secure shell file transfer protocol (sftp), file transfer protocol (ftp), from a file system (file), etc. The resources portion of the instruction includes a list 154 comprising the portion of the necessary computing resources 156 needed to carry out the associated one of said tasks 152. In this example, the “cpus=3” indicates that three central processing units are needed, “cputype=×64” indicates an x64 type central processing unit is needed, “fpga=virtex7” indicates that a Virtex 7 FPGA is needed, “asic=SHA2” indicates than ASIC that can perform the SHA-2 hash method is needed, “ram=128gb” indicates that 128 gigabytes of random access memory are needed, and “nvm=2tb” indicates that 2 terabytes of nonvolatile storage is needed, for example, rotating media or solid state storage. The begintime portion of the instruction 150 indicates the time at which the director computer 130 should cause 138 the bank of computers 100 to start performing the one of said tasks 152, in this case, start the execution of the virtual machine. The endtime portion of the instruction 150 indicates the time at which the director computer 130 should cause 138 the bank of computers 100 to cease performing the one of said tasks 152, in this case, halt the execution of the virtual machine. Other representations of a list 154 comprising a portion of computing resources 156 needed to carry out the associated one of said tasks 152 than textual representations, and other descriptions of computing resources may be devised by a person skilled in the art.

The instruction 150 may be signed by an associated cryptographic key 122, which is associated with an account 114 that possesses a non-fungible token 116. As stated earlier, the account 114 which the non-fungible token 116 was most recently transferred to is the possessor of the non-fungible token 116. The one of said tasks has a list 154 comprising a portion of the computing resources 156 needed to carry out the associated one of said tasks 152. The list 154 may be included in the instruction 150. The list 154 may be in a file, table, or local or remote database accessible to the director computer 130 so that the director computer 130 retrieves the list 154 based on the instruction 150, the identity of the non-fungible token 116, the type of the one of said tasks 152, an identity of the one of said tasks 152, or a combination of these. Examples of the types of one of said tasks 152 include a cryptocurrency mining type, a virtual machine type, and a container type. The portion of the computing resources 156 may include a specification of one or more computing hardware items such as a computer processor, memory, network connectivity, application specific integrated circuits, field programmable gate arrays, or a specification of software such as an operating system, database software, numerical processing software, cryptocurrency mining software, a specification of a computational capacity or rate, or a specification of a time limit or time interval, etc.

The director computer 130 determines 132 whether the instruction 150 is signed by the cryptographic key 122. If the associated cryptographic key 122 is a private key or a private/public key pair of an asymmetric key cipher, then a director computer 130 may determine 132 whether the instruction 150 is signed by the cryptographic key 122 by verifying the signature on the instruction 150 using the public key of the private/public key pair. The public key may be the identifier or address of the account 114 that is the possessor of the non-fungible token 116, and may be obtained from the record of a transfer 112 of the non-fungible token 116 to the account 114. Alternatively, the director computer 130 may retrieve the public key from a database of public keys based on the identity of the account 114, and the public keys in the database may be contained within public key certificates that have been signed by a key certification authority with the certificate authenticated using a public key of a key certification authority.

If the instruction 150 is signed 132 by the cryptographic key 122, compare the list 154 with the list of authorized computing resources 136 to determine whether the portion of computing resources 156 is sufficient 134 to perform the associated one of said tasks 152. The instruction 150 may contain an identifier of or reference to the non-fungible token 116, and the director computer 130 obtains the list of authorized computing resources 136 from the record on the distributed ledger 110 containing the non-fungible token 116 or the director computer 130 retrieves the list of authorized computing resources 136 from a source indicated by a pointer 120 to the list of authorized computing resources 136 obtained from the record on the distributed ledger 110 containing the non-fungible token 116. A method, but not the only method, for the director computer to determine whether the portion of computing resources is 156 is sufficient 134 is for the director computer 130 to determine if there is an item in the list of authorized computing resources 136 of equal or greater capability or capacity corresponding to each item in the list 154 comprising a portion of the computing resources 156 needed to carry out the associated one of said tasks 152. For example, an item on the list 154 may comprise the specification of a first quantity of memory, and an item on the list of authorized computing resources 136 may comprise the specification of a second quantity of memory, with the portion of computing resources corresponding to the memory being sufficient 134 is the second quantity of memory is greater than or equal to the first quantity. Similarly, an item on the list 154 may comprise the specification of a first central processing unit with certain capabilities, and an item on the list of authorized computing resources 136 may comprise the specification of a second central processing unit with certain capabilities, with the portion of computing resources corresponding to the central processing unit being sufficient 134 if the second specified central processing unit has at least the capabilities in the specification of the first central processing unit. Similarly, an item on the list 154 may comprise the specification of a first cryptocurrency miner with a hashrate, and an item on the list of authorized computing resources 136 may comprise a specification of a second cryptocurrency miner with a hashrate, with the portion of computing resources corresponding to the cryptocurrency mining being sufficient 134 if the second specified hashrate is greater than or equal to the first hashrate. Similarly, an item on the list 154 may comprise a specification of a first time interval, and an item on the list of authorized computing resources 136 may specify a second time interval, with the portion of computing resources associated with the time interval being sufficient 134 if the start time of the second time interval is at or before the start time of the first time interval and the end time of the second time interval is at or after the time of the end time of the first time interval. Other examples of a portion of the computing resources being sufficient 134 may be devised by one who is skilled in the art.

In addition, a specification included in the list of authorized computing resources 136 or included in the list 154 comprising a portion of the computing resources 156 needed to carry out the associated one of said tasks 152 may be a matched pattern, wildcard, or regular expression. A matched pattern, wildcard, or regular expression may specify a pattern that can be matched to text or a string of symbols to determine if the text or the string of symbols matches the pattern. An identity of a computing resource may be denoted by a text or a string of symbols, so that if an item in a list of authorized computing resources 136 or in the list 154 is specified by a matched pattern, and a text or a string of symbols identifying a computing resource matches the matched pattern, the computing resource would be included in the list.

If the instruction 150 is signed 132 by the cryptographic key 122 and the portion of the computing resources 156 is sufficient 134, the director computer 130 causes 138 the associated one of said tasks 152 to be performed on the bank of computers 100. If the instruction 150 is not signed 132 by the cryptographic key 122 or if the portion of the computing resources 156 is not sufficient 134, then the director computer 130 does not cause 140 the associated one of said tasks 152 to be performed and may perform a predetermined action. The director computer 130 may cause 138 the associated one of said tasks 152 to be performed on the bank of computers 100 by instructing one or more computers of the bank of computers 100 to perform the associated one of said tasks 152. The director computer 130 and the bank of computers 100 may be connected by a network, for example, a local area network, a wide area network, or a wireless network, or a combination of these. The bank of computers 100 may also be connected together by a network, such as a local area network, a wide area network, or a wireless network, or a combination of these. The director computer 130 may cause 138 the associated one of said tasks 152 to be performed on the bank of computers 100 by communicating an instruction to the bank of computers 100 over a network connecting the director computer 130 and the bank of computers 100. The instruction to the bank of computers 100 can be communicated over the network using a protocol such as a remote shell (RSH), a secure shell (SSH), a remote procedure call (RPC), by using a remote execution program, a remote desktop connection, a customized client and server protocol, etc.

The director computer 130 may transfer any information needed to perform the associated one of said tasks 152 to the bank of computers 100 when causing 138 the associated one of said tasks 152 to be performed on the bank of computers 100, for example, information regarding a list of computing resources 102 to be used to perform the associated one of said tasks 152, any data or pointers to said data needed to perform the associated one of said tasks 152, the sources of any inputs needed by the associated one of said tasks 152, the destinations of any outputs needed by the associated one of said tasks 152, etc. The sources of any inputs or the destinations of any outputs may be specified by a location in a filesystem, a table or database, a network socket, uniform resource identifier, a network address on a local or wide area network, or a combination of these. The director computer 130 may obtain in part the information to transfer to the bank of computers 100 from an instruction 150 or a file, table, or local or remote database accessible to the director computer 130. In an alternate embodiment, the director computer 130 may maintain a record of tasks 104 being performed on the bank of computers 100 and computing resources 102 being utilized on the bank of computers 100 to determine if the computing resources 102 are available to perform the associated one of said tasks 152. If the computing resources 102 are available to perform the associated one of said tasks 152, and the instruction 150 to perform one of said tasks 152 is signed 132 by the cryptographic key 122, and the portion of the computing resources 156 needed to carry out the associated one of said tasks 152 is sufficient 154, the director computer 130 causes 138 the associated one of said tasks 152 to be performed on the bank of computers 100. The director computer 130 may select one or more computers in the bank of computers 100 based on the available computing resources 102 of the one or more computers, and cause 138 the associated on of said tasks 152 to be performed on the one or more computers. If computing resources 102 are not available to perform the associated one of said tasks 152, but the instruction 150 to perform one of said tasks 152 is signed by the cryptographic key 122, and the portion of the computing resources 156 needed to carry out the associated one of said tasks 152 is sufficient 154, the director computer 130 may take a predetermined action and may wait until the computing resources 102 are available and then cause 138 the associated one of said tasks 152 to be performed on the bank of computers 100, or the director computer 130 may not cause 140 the associated one of said tasks 152 to be performed and wait for an 150 instruction to perform the associated one of said tasks 152.

In an alternative but not exclusive embodiment, the non-fungible token 116 may include a pointer 120 to a list of authorized computing resources 136. The pointer 120 may be a content address or a content identifier that is a SHA-256 hash of a file on the InterPlanetary File System (IPFS). The file on the IPFS may be accessed by the director computer 130 by using the pointer 120 which is the content identifier included in the non-fungible token 116. This file may include a list of authorized computing resources 136, for example, in the form of text or a JSON object. In an embodiment, this file may be cryptographically signed by an authoritative source. If the signature on the file is verified by the director computer 130 and the verified signature is of an authoritative source, the director computer 130 recognizes the included list of authorized computing resources as having been produced by an authoritative source. The director computer 130 may obtain the identities of authoritative sources from a file, table, or a local or remote database. The keys, such as public keys, which may be used to verify the signature may be obtained from a database of public keys or from a file, table, or a local or remote database. If the director computer 130 does not verify the identity of the signer of the file as an authoritative source, the director computer 130 may not process the instruction 150 and likewise may not 138 cause the associated one of said tasks 152 to be performed on the bank of computers 100. If the file is recognized by the director computer 130 as having been cryptographically signed by an authoritative source, or if the director computer 130 does not require a signature on the file, the director computer 130 may use a list of authorized computing resources 136 present in the file.

The list of authorized computing resources 136 may be represented as text, for example, that is included in the record of a non-fungible token 116 on the distributed ledger 110, or as text in a file that is accessible by a pointer 120 to the list of authorized computing resources 136. As an example, the text encoding a list of authorized computing resources corresponding to authorized cryptocurrency mining capacity may be “{tokenid: <tokenid>, rate: 20000000000, begintime: 20220401000000UTC, endtime: 20220430235959UTC}”. The tokenid portion of the list of authorized computing resources 136 denotes the identifier of the non-fungible token 116 on the distributed ledger 100 which is the non-fungible token 116 that includes the list of authorized computing resources 136 or includes the 120 pointer to the list of authorized computing resources 136, and may be excluded if the identity of the list of authorized computing resources 116 is included in the same record in the distributed ledger 110 as the non-fungible token 116. The rate portion of the list of authorized computing resources 136 denotes a hash rate that is a total hash rate. If the sum of the hash rates on the lists 154 of the associated ones of said tasks that are compared with a list of authorized computing resources 136 is less than or equal to the total hash rate in the list of authorized computing resources 136, the portion of the computing resources 156 corresponding to the total hash rate is sufficient 134. The director computer 130 limits the sum of the hash rates of the ones of said tasks 152 that the director computer 130 causes to be performed on the bank of computers 100 authorized by the non-fungible token 116 to the total hash rate in the list of authorized computing resources 136 corresponding to the non-fungible token 116. The begintime portion of the list of authorized computing resources 136 indicates the start time of an interval, and the endtime portion of the list of authorized computing resource 136 indicates the end time of an interval. If an interval contained in a list 154 specifying the interval of time over which the one of said tasks 152 should be performed is contained within the interval contained within the list of authorized computing resources 136 indicated by begintime and endtime, the portion of the computing resources 156 corresponding to the interval is sufficient 134. If there are portions of the interval contained in a list 154 specifying the interval of time over which the one of said tasks 152 should be performed that are not contained within the interval contained within the list of authorized computing resources 136 indicated by begintime and endtime, the portion of the computing resources 156 corresponding to the interval is not sufficient 154. If both the portion of the computing resources 156 corresponding to the total hash rate is sufficient 134 and the portion of the computing resources 156 corresponding to the interval is sufficient 134, the portion of the computing resources 156 is sufficient 134 to perform the associated one of said tasks 152. Other representations of a list of authorized computing resources 136 than textual representations, and other descriptions of computing resources for cryptocurrency mining tasks may be devised by a person skilled in the art.

As an example, the text encoding a list of authorized computing resources corresponding to authorized virtual machine execution capacity may be “{tokenid: <tokenid>, resources: vms=4, cpus=4, cputype=×64,ARM,fpga=“virtex7,virtex5”, asic=sha2,ram=1024gb, nvm=10tb begintime: 2022040101000000UTC, endtime: 2023040101000000UTC}”. The tokenid portion of the list of authorized computing resources 136 denotes the identifier of the non-fungible token 116 on the distributed ledger 100 which is the non-fungible token 116 that includes the list of authorized computing resources 136 or includes the 120 pointer to the list of authorized computing resources 136, and may be excluded if the identity of the list of authorized computing resources 116 is included in the same record in the distributed ledger 110 as the non-fungible token 116. The vms portion of the list of authorized computing resources 136 denotes a total number of virtual machines. If the total of the virtual machines on the lists 154 of the associated ones of said tasks that are compared with a list of authorized computing resources 136 is less than or equal to the total number of virtual machines in the list of authorized computing resources 136, the portion of the computing resources 156 is sufficient 134 to perform the ones of said tasks 152. The director computer 130 limits the sum of the number of the virtual machines of the ones of said tasks 152 that the director computer 130 causes to be performed on the bank of computers 100 authorized by a non-fungible token 116 to the total number of virtual machines in the list of authorized computing resources 136 corresponding to the non-fungible token 116. The cpus portion of the authorized computing resources 136 denotes a maximum number of central processing units permitted to a virtual machine. If a list 154 comprising a portion of the computing resources needed to carry out the associated one of said tasks 152 specifies a number of central processing units less than or equal to the maximum number of central processing units included in the list of the authorized computing resources 136, the portion of the computing resources 156 corresponding to the number of central processing units is sufficient 134. The cputype portion of the authorized computing resources 136 denotes which types of central processing units are permitted to a virtual machine. If a list 154 comprising a portion of the computing resources needed to carry out the associated one of said tasks 152 specifies types of central processing units, and all of these types of central processing units are included in the list of allowed types of central processing units included in the list of the authorized computing resources 136, the portion of the computing resources 156 corresponding to the types of central processing units is sufficient 134. The fpga portion of the authorized computing resources 136 denotes which types of field programmable gate arrays are permitted to a virtual machine. If a list 154 comprising a portion of the computing resources needed to carry out the associated one of said tasks 152 specifies types of a field programmable gate array, and all of these types of a field programmable gate array are included in the list of allowed types of a field programmable gate array included in the list of the authorized computing resources 136, the portion of the computing resources 156 corresponding to the types of a field programmable gate array is sufficient 134. The asic portion of the authorized computing resources 136 denotes which types of an application specific integrated circuit are permitted to a virtual machine. If a list 154 comprising a portion of the computing resources needed to carry out the associated one of said tasks 152 specifies types of an application specific integrated circuit, and all of these types of an application specific integrated circuit are included in the list of allowed types of an application specific integrated circuit included in the list of the authorized computing resources 136, the portion of the computing resources 156 corresponding to the types of application specific integrated circuits is sufficient 134. The ram portion of the authorized computing resources 136 denotes a maximum quantity of random access memory permitted to a virtual machine. If a list 154 comprising a portion of the computing resources needed to carry out the associated one of said tasks 152 specifies a quantity of random access memory less than or equal to the maximum quantity of random access memory included in the list of the authorized computing resources 136, the portion of the computing resources 156 corresponding to the quantity of random access memory is sufficient 134. The nvm portion of the authorized computing resources 136 denotes a maximum quantity of nonvolatile memory such as rotating media storage or solid state storage permitted to a virtual machine. If a list 154 comprising a portion of the computing resources needed to carry out the associated one of said tasks 152 specifies a quantity of nonvolatile memory less than or equal to the quantity of nonvolatile memory included in the list of the authorized computing resources 136, the portion of the computing resources 156 corresponding to the quantity of nonvolatile memory is sufficient 134. The begintime portion of the list of authorized computing resources 136 indicates the start time of an interval, and the endtime portion of the list of authorized computing resource 136 indicates the end time of an interval. If an interval contained in a list 154 specifying the interval of time over which the one of said tasks 152 should be performed is contained within the interval contained within the list of authorized computing resources 136 indicated by begintime and endtime, the portion of the computing resources 156 corresponding to the interval is sufficient 134. If the portion of the computing resources 156 corresponding to the total number of virtual machines is sufficient 134, and the portion of the computing resources 156 corresponding to the number of central processing units is sufficient 134, and the portion of the computing resources 156 corresponding to the types of central processing units is sufficient 134, and the portion of the computing resources 156 corresponding to the types of a field programmable gate array is sufficient 134, and the portion of the computing resources 156 corresponding to the types of an application specific integrated circuit is sufficient 134, and the portion of the computing resources 156 corresponding to the quantity of random access memory is sufficient 134, and the portion of the computing resources 156 corresponding to the quantity of nonvolatile memory is sufficient 134, and the portion of the computing resources 156 corresponding to the interval is sufficient 134, the portion of the computing resources 156 is sufficient 134 to perform the associated one of said tasks 152. Other representations of a list of authorized computing resources 136 than textual representations, and other descriptions of computing resources for virtual machine tasks may be devised by a person skilled in the art.

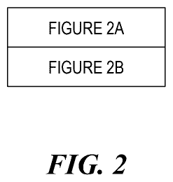

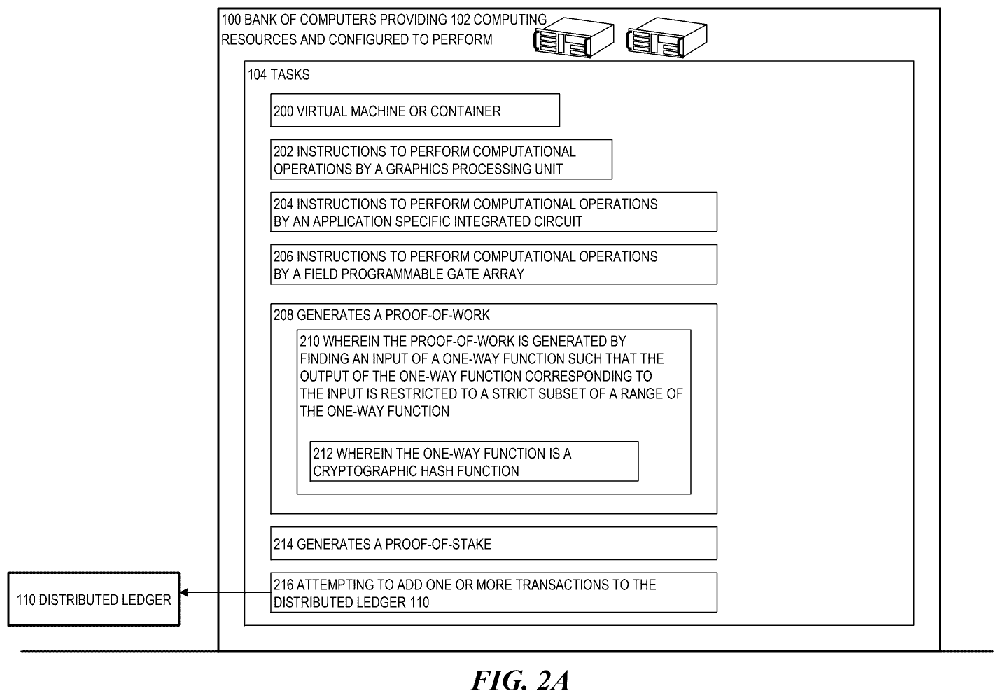

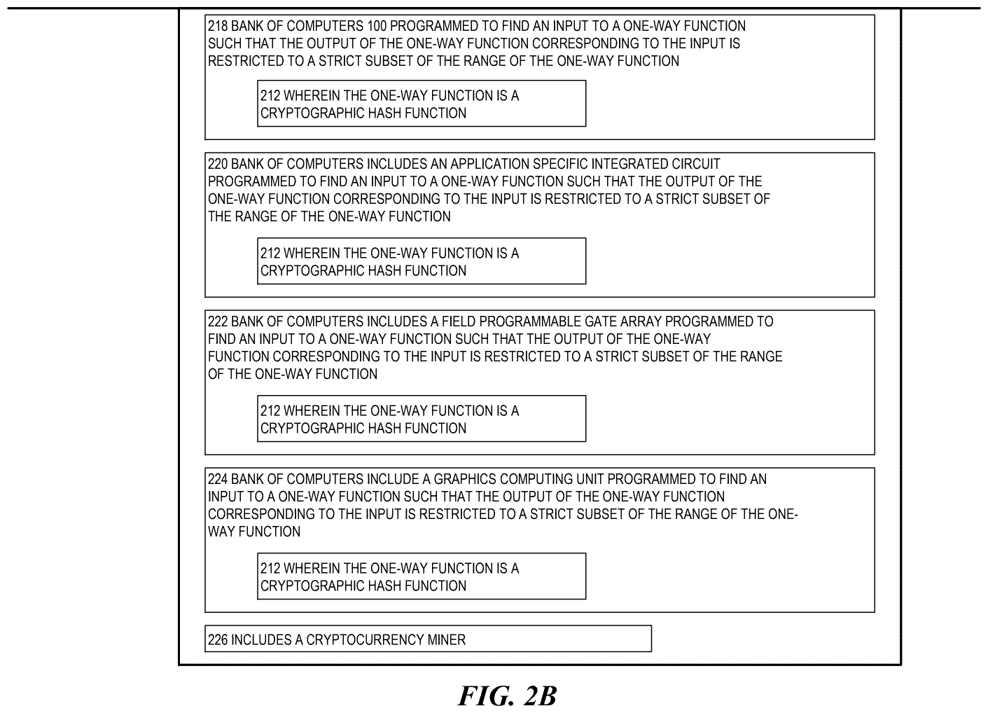

FIG. 2 is an illustration of embodiments of the bank of computers 100. A bank of computers may be configured to perform many types of tasks 104. The tasks 104 utilize the computing resources 102 of the bank of computers 100, and so the types of task 104 that may be performed 104 on the bank of computers 100 are partially determined by the computing resources 102.

For example, a task 104 may include at least one of a virtual machine or container. The one task 152 may include at least one of a virtual machine or a container 200. A bank of computers 100 may be programmed with virtualization software, examples being Virtualbox, VMWare, Xen, or KVM. Alternatively, a bank of computers 100 may be programmed with container software such as Docker. A task 104 may execute a virtual machine or container with its data included in a file or an image containing a program to be executed within the virtual machine or container as well as other data to be used by the program. Data not included in the file or image may be obtained by the task 104 from the director computer 130 or a server that can serve data files such as a file server or a web server. The identity of the file or image to be used by the virtual machine or container software may be provided in whole or in part by the instruction 150. The specification of the virtual machine or container, for example in a list 154 comprising a portion of the computing resources 156 needed to carry out the associated one of said tasks 152, or in the list of authorized computing resources 136, may contain one or more identities of files, data, or images to be utilized by the virtual machine or container, types of central processing units, a number of central processing units, amount of random access memory, amount of nonvolatile memory, identity of computer networks, network addresses on computer networks, identifiers of virtual private networks, identifiers of at least one computer or a network address on a virtual private network, identifier of a computer within the bank of computers 100, a type of graphics computing unit, a number of graphics computing units, types of application specific integrated circuits, a number of application specific integrated circuits, types of field programmable gate arrays, a number of field programmable gate arrays, an interval of time, a number of communications on a computer network, a time rate of communications on a computer network, a number of computational operations, a number of computational operators, and a time rate of computational operations, an interval of time, etc. The task 104 may be configured to obtain input data from a local or remote file system, network socket, or removable or portable media, etc. The task 105 may be configured to deposit output data to a local or remote file system, to a network socket, or to removable or portable media, etc. The locations of the input data and the output data may be provided in the instruction 150. The director computer 130 may cause one or more computers of the bank of computers 100 to perform a task 104 that includes a virtual machine or container by sending a command to the one or more computers to start the virtual machine software or container software, providing the virtual machine or container software parameters for the command or a configuration file for the virtual machine software or container software that include the files or data to be utilized by the virtual machine or container, as well as the information regarding any computer resources 102 to be utilized by the virtual machine or container.

The one task 152 may include instructions to perform computational operations by a graphics processing unit 202. The one task 152 may include instructions to perform computational operations by an application specific integrated circuit 204. The one task 152 may include instructions to perform computational operations by a field programmable gate array 206. Instructions to perform computational operations by at least one of a graphics processing unit, an application specific integrated circuit, or a field programmable gate array may be included for example, into a virtual machine or container task 104. These instructions may be included in a file or an image containing a program to be executed within the virtual machine or container as well as other data to be used by that program. The instructions may already be present in a program stored on the bank of computers 100 that is executed in whole or in part as one of said tasks 152. The instructions may be present but not executed, or be executed contingent on the availability of a computing resource 102 to the bank of computers 100. The instructions may query the bank of computers 100 for the available computer resources 102 and alter the execution of the instructions based on the available computer resources. The instruction 150 may contain information or parameters that are conveyed to the bank of computers 100 by the director computer 130, for example, when the director computer 138 causes the associated one 152 of said tasks to be performed on the bank of computers 100. Based on the information or parameters, the task 104 may select a group of instructions to perform computational operations on an application specific integrated circuit, a field programmable gate array, or a graphics processing unit, for example, the types of computations or precision of the computations performed.

The one task 152 may generate a proof-of-work 208. The one task 152 may generate the proof-of-work wherein the proof-of-work is generated by finding an input of a one-way function such that output of the one-way function corresponding to the input is restricted to a strict subset of a range of the one-way function 210. The range of a function is understood to indicate the set for which the elements of that set are all of the possible values of the output of a function. A strict subset of the range of a function indicates a set that may contain only elements present in the range of the function, but must exclude at least one element of the range of the function. A one-way function may be a cryptographic hash function 212. A one-way function is a function for which, given a target output or set of outputs of the one-way function, no method of finding an input to the function that produces a target output finds the answer with significantly less effort than a method that exhaustively tests inputs to the one-way function. An example of a task that may generate a proof-of-work is a cryptocurrency mining task. Such a task may include finding, for example, an input to a cryptographic hash function such as SHA-256 such that the output of the cryptographic hash function that is less than a target number. A cryptographic hash function is an example of a function intended to be a one-way function, and SHA-256 is a function that is currently believed to be a one-way function. The one task 152 may generate a proof-of-stake 214.

The one task 152 may attempt 216 to add one or more transactions to the distributed ledger 110. A bank of computers 100 that performs a task 104 that includes cryptocurrency mining may attempt to add transactions to a distributed ledger 110. For a distributed ledger 110 that is a blockchain, the transactions may be grouped into blocks, and the cryptocurrency mining task may need to solve a proof-of-work problem dependent on data within the block that is verified by nodes on the blockchain network. If and only if the proof-of-work problem is verified is the block added to the blockchain, where the block includes the transactions and the blockchain is the distributed ledger 110. For any given block, a cryptocurrency miner is unlikely to succeed in solving a proof-of-work problem before any of the other cryptocurrency miners also working on a block, and so a cryptocurrency miner only attempts to add the transactions to the distributed ledger 110, and it may not succeed. The task of cryptocurrency mining may then be a means, but not necessarily the only means, that a one task 152 may attempt to add one or more transactions to the distributed ledger 110.

The bank of computers 100 may be programmed to find the input to a one-way function such that the output of the one-way function corresponding to the input is restricted to a strict subset of the range of the one-way function 218, and the programming may be implemented by software or hardware in a cryptocurrency miner such as a Bitcoin miner. A one-way function may be a cryptographic hash function 212. The bank of computers 100 may include an application specific integrated circuit programmed to find the input to a one-way function such that the output of the one-way function corresponding to the input is restricted to a strict subset of the range of the one-way function 220, with the application specific integrated circuit being designed to calculate at least one of a one-way function or cryptographic hashes to increase the hashrate of a cryptocurrency miner. A one-way function may be a cryptographic hash function 212. The bank of computers 100 may include a field programmable gate array programmed to find the input to a one-way function such that the output of the one-way function corresponding to the input is restricted to a strict subset of the range of the one-way function 222, with the field programmable gate array being programmed to calculate at least one of a one-way function or cryptographic hashes to increase the hashrate of a cryptocurrency miner. A one-way function may be a cryptographic hash function 212. The bank of computers 100 may include a graphics processing unit programmed to find the input to a one-way function such that the output of the one-way function corresponding to the input is restricted to a strict subset of the range of the one-way function 224, with the graphics processing unit being programmed to calculate at least one of a one-way function or cryptographic hashes to increase the hashrate of a cryptocurrency miner. A one-way function may be a cryptographic hash function 212. The bank of computers 100 may include a cryptocurrency miner 226, for example a Bitcoin miner such as an Antminer S19 Pro, Antminer T17, Whatsminer M30S+, AvalonMiner A1166 Pro, etc.

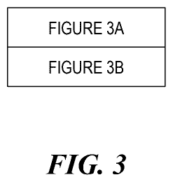

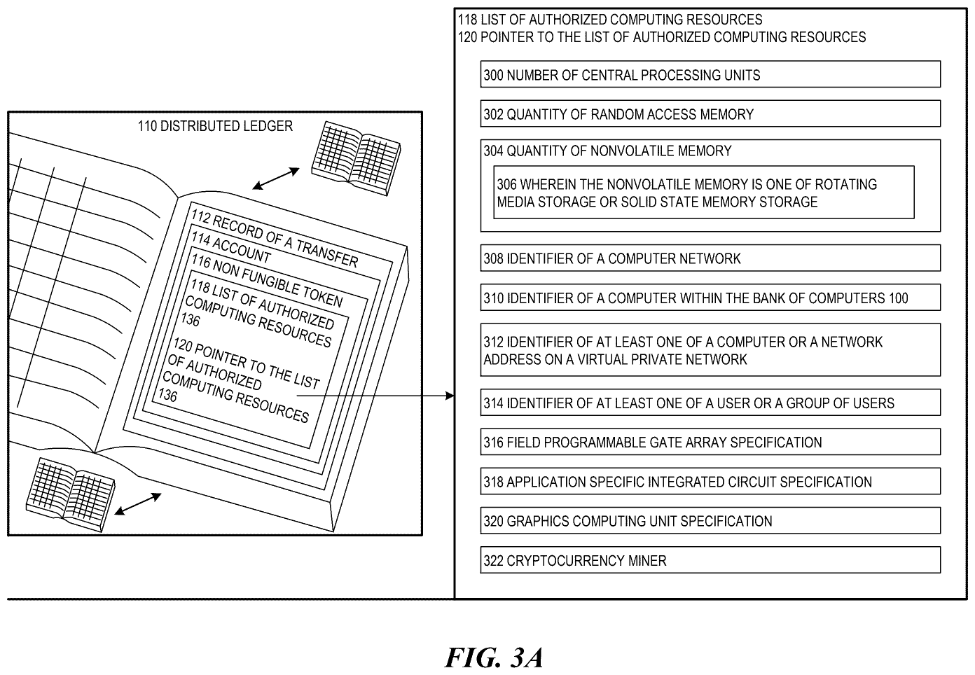

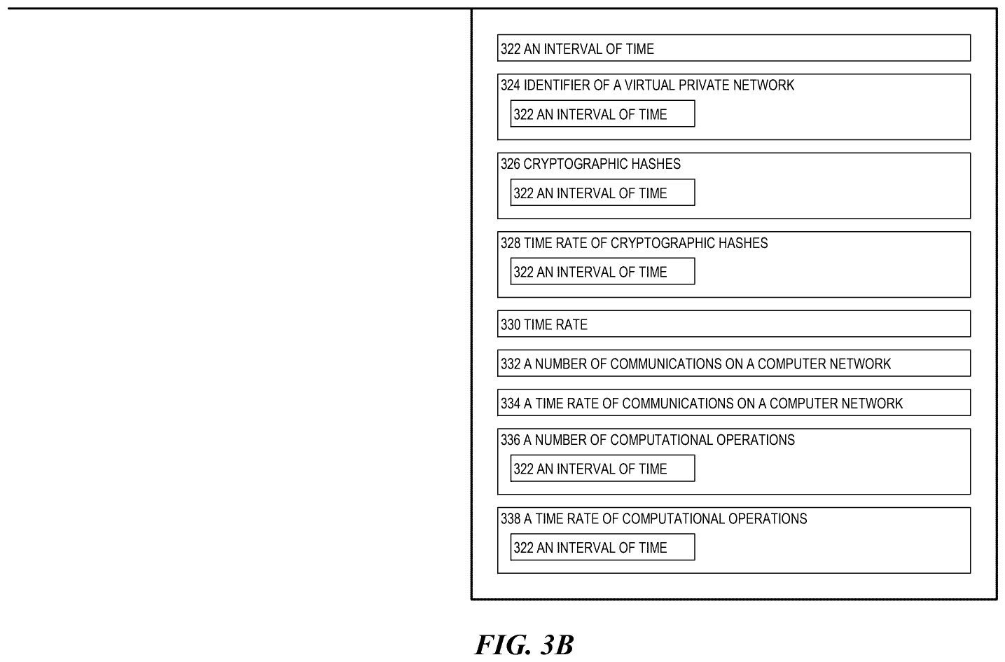

FIG. 3 is an illustration of embodiments of lists 118 of authorized computing resources 136. A list of authorized computing resources 136 may include a number of central processing units 300. For example, a list of authorized computing resources 136 could include a number of four central processing units, for example, if four central processing units of a type x64 architecture are authorized. A list of authorized computing resources 136 may include types of central processing units and a corresponding authorized number of central processing units of each type. A list of authorized computing resources 136 may include a quantity of random access memory 302. The quantity of random access memory may be specified by a number of bytes, for example. Random access memory may also be specified by a type, and the type of random access memory may correspond to a storage and retrieval speed or a cache level of memory. A list of authorized computing resources 136 may include types of random access memory and a corresponding authorized quantity of random access memory of each type. A list of authorized computing resources 136 may include a quantity of nonvolatile memory 304. The nonvolatile memory 304 may be one of rotating media storage or solid state flash memory storage 306. The quantity of nonvolatile memory may be specified by a number of bytes, for example. Nonvolatile memory may also be specified by a type, and the type of nonvolatile may correspond to a storage and retrieval mechanism, for example, stored and retrieved from a rotating magnetic medium, rotating optical medium, or stored and retrieved from a solid state flash memory. A list of authorized computing resources 136 may include types of nonvolatile and a corresponding authorized quantity of nonvolatile memory of each type.

A list of authorized computing resources 136 may include an identifier of a computer network 308. The identifier of a computer network may be a subnet on an internet protocol network, a fully qualified domain name, a domain name, or a hostname or a network name matched by a wildcard expression or a regular expression, etc. The identifier of a computer network may be a credential, password, or secret key needed to access the computer network. A list of authorized computing resources 136 may include an identifier of a computer within the bank of computers 100. An identifier of a computer within the bank of computers 100 may be a network address, internet protocol address, hostname, a hostname matched by a wildcard expression or a regular expression, a unique identifier assigned by, for example the director computer 130, to each computer in the bank of computers 100, etc. A list of authorized computing resources 136 may include the identifier of at least one of a computer or a network address on a virtual private network 312. An identifier of at least one of a computer or a network address on a virtual private network may be an internet protocol address, network address, hostname, a hostname or a network name matched by a wildcard expression or a regular expression, the computer or network address being accessible on a virtual private network. An identifier of at least one of a computer or a network address on a virtual private network may include an identifier of a virtual private network, for example a RFC 2685 Virtual Private Networks Identifier. A list of authorized computing resources 136 may include an identifier of at least one of a user or a group of users 314. An identifier of a user may be an identity of a user stored in a file, table, or database of users accessed by the director computer 130. An identifier of a group may be an identity of a group stored in a file, table, or database of users accessed by the director computer 130. An identifier of a user or a group may be retrievable by the director computer 130 from a directory lookup service.

A list of authorized computing resources 136 may include a field programmable gate array specification 316. A field programmable gate array specification may include a model name of a field programmable gate array, a part number of a field programmable gate array, an identifier of the field programmable gate array on a USB or PCI Express bus, a serial number of a field programmable gate array, a number of system gates, a number of logic blocks, a number of registers, a number of lookup tables, a clock frequency, a number of input output pins, an identity of a field programmable gate array intellectual property cores, a high speed serial interface, a high speed parallel interface, an amount of power consumption, an amount of auxiliary memory available to the field programmable gate array, etc. The quantified specifications may be specified within a range, for example, with a minimum and maximum range of acceptability. A list of authorized computing resources 136 may include an application specific integrated circuit specification 318. An application specific integrated circuit specification may include a model name of an application specific integrated circuit, a part number of an application specific integrated circuit, a serial number of an application specific integrated circuit, an identifier of the application specific integrated circuit on a USB or PCI Express bus, a number of computations, a time rate of computation, a type of computation, etc. The type of computation may be specified, for example, as cryptographic hashes such as SHA-2 cryptographic hashes, operations on an elliptic curve finite field, operations on a cyclic finite field, floating point operations, etc. A list of authorized computing resources 136 may include a graphics computing unit specification 320. A graphics computing unit specification may include a model name of a graphics computing unit, a part number of a graphics computing unit, a serial number of a graphics computing unit, an identifier of the graphics computing unit on a USB or PCI Express bus, a quantity of memory, a number of cores, a core clock speed, a memory type, a memory bandwidth rate, an identifier of a graphics computation standards such as OpenGL, CUDA, or OpenCL, and a number or other identifier of a version of a graphics computation standard.

A list of authorized computing resources 136 may include a cryptocurrency miner 322. A cryptocurrency miner included in a list of authorized computing resources 136 may be specified by a particular hostname, serial number, network address, or MAC address of a cryptocurrency miner, or the identity of a cryptocurrency miner in a file, table, or database accessible to the director computer 130. A cryptocurrency miner included in a list of authorized computing resources 136 may be specified by a particular model of cryptocurrency miner, a type of computation such as a cryptographic hash or a mathematical operation, a time rate of computations such as a time rate of cryptographic hashes, the identities of particular blockchains, the identities of particular cryptocurrencies, the identities of cryptographic pools, etc. Types of cryptographic hashes include SHA-2, SHA-256, Keccak-256, and SHA-3. Types of computations that are mathematical operations include operations over an elliptic curve finite field or a cyclic finite field.

A list of authorized computing resources 136 may include an interval of time 322. An interval of time 322 may be specified by a start time and date and end time and date, with the time and date given for example as UTC. An interval of time 322 may be specified as a period of time with its start time and date triggered by a particular event, and its end time given by an elapsed time after the start time. For example, the event that triggers the start the interval may be the director computer 130 causing 138 the associated one of said tasks 152 to be performed on the bank of computers 100, with the identity of the associated one of said tasks 512 specified, as well as the duration of the elapsed time after the event after which the interval ends being specified.

A list of authorized computing resources 136 may include an identifier of a virtual private network 324. A list of authorized computing resources 136 that includes the identifier of a virtual private network 324 may also include an interval of time 322. The identifier of a virtual private network may be a subnet on an virtual private network, a fully qualified domain name corresponding to the network address on a virtual private network, a domain name corresponding to network addresses on a virtual private network, or a host name or address matched by a pattern, wildcard expression, or a regular expression, etc. of hosts on a virtual private network. The identifier of a virtual private network may be a RFC 2685 Virtual Private Networks Identifier.

A list of authorized computing resources 136 may include cryptographic hashes 326. A list of authorized computing resources 136 that includes cryptographic hashes 326 may also include an interval of time 322. Cryptographic hashes may be specified on a list of authorized computing resources 136 as a number of cryptographic hashes, or as a type of cryptographic hashes, or both. A type of cryptographic hashes includes cryptographic hash types such as SHA-2, SHA-256, Keccak-256, and SHA-3. A list of authorized computing resources 136 may include a time rate of cryptographic hashes 328. A list of authorized computing resources 136 that includes a time rate of cryptographic hashes 326 may also include an interval of time 322. A time rate of cryptographic hashes may be specified on a list of authorized computing resources 136 as a number of cryptographic hashes over a unit of time, for example 10 terahash per second, and may include a type of cryptographic hashes. A list of authorized computing resources 136 may include a time rate 330. A time rate of a quantity of a computing resource may be specified on a list of authorized computing resources 136 as a quantity of a computing resource 104 over a unit of time. For example, a time rate may be a number of joules per second, or watts, with the energy being consumed by a computing resource being specified in joules.

A list of authorized computing resources 136 may include a number of communications of a computer network 332. The number of communications on a computer network may be specified on a list of authorized computing resources 136 as a number of bits, bytes, symbols, frames, or packets. A list of authorized computing resources 136 may include a time rate of communications of a computer network 334. The time rate of communications on a computer network may be specified on a list of authorized computing resources 136 as a number of bits, bytes, symbols, frames or packets communicated through a channel or network during a unit time. For example, a time rate of communications may be a megabit per second to denote one million bits passing over a communications channel in a second, the unit time being a second.

A list of authorized computing resources 136 may include a number of computational operations 336. A list of authorized computing resources 136 that includes a number of computational operations 336 may also include an interval of time 322. A number of computational operations may be specified on a list of authorized computing resources 136 as a number of computational operations with a type of a computational operation. Types of computational operations include boolean logic operations, integer arithmetic operations, operations on an elliptic curve finite field, operations on a cyclic finite field, floating point operations, etc. The type of computational operation may also include a specification for the number of bits operated on or of a finite field, for example the elliptic curve of an elliptic curve finite field. A list of authorized computing resources 136 may include a time rate of computational operations 336. A list of authorized computing resources 136 that includes a time rate of computational operations 336 may also include an interval of time 322. A time rate of computational operations may be specified on a list of authorized computing resources 136 as a number of computational operations occurring over a unit time with a type of computational operation. For example, a time rate of computational operations may be one million elliptic curve finite field operations per second, with the computational operation being an operation on an elliptic curve finite field, and the unit time being a second.

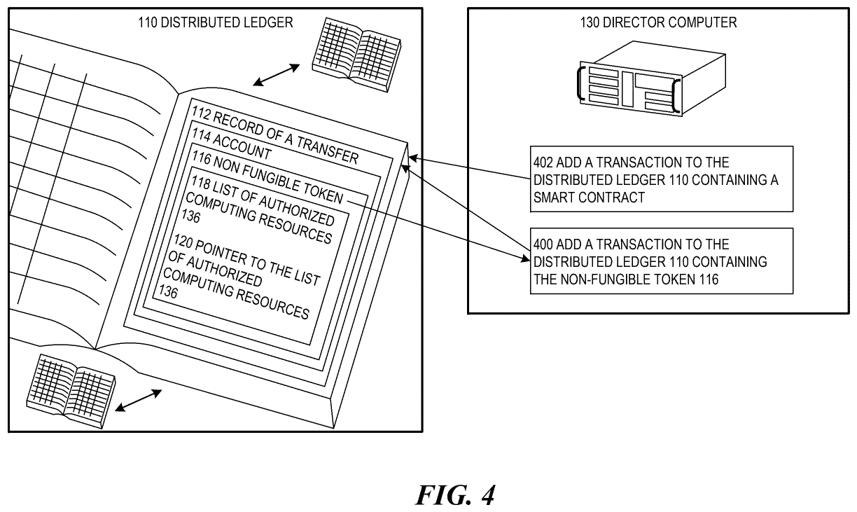

FIG. 4 is an illustration of embodiments of adding transactions to the distributed ledger 110. A director computer 130 may identify a non-fungible token 116 in a record of a transfer 112 to an account 114. The director computer 130 may add a transaction 400 to the distributed ledger 110 containing the non-fungible token 116. For example, the director computer 130 may add a transaction to the distributed ledger 100, wherein the transaction is a record of a transfer 112 of the non-fungible token 116 to an account 114. As another example, the director computer 130 may add a transaction to the distributed ledger 100, wherein the transaction is an establishment (or minting) of a non-fungible token 116, wherein the establishment of the non-fungible token 116 is a record of a transfer 112 of the non-fungible token 116 to an account 114. In some embodiments, the establishment of a non-fungible token 116 may be the transfer 112 of the non-fungible token 116 from an account 114 with an invalid identifier, such as an identifier of zero or other number designated to be an invalid identifier, to an account 114 with a valid identifier. Likewise, the non-fungible token 116 may be disestablished (or burned) by adding a record of a transfer 112 to the distributed ledger 100 from an account 114 with a valid identifier to an account 114 with an invalid identifier, or an account 114 designated to make the non-fungible token 116 irretrievable. If the non-fungible token 116 is implemented in part by a smart contract, the director computer 130 may add other transactions 400 to the distributed ledger containing the non-fungible token 116 as permitted by the smart contract. The director computer 130 may add a transaction 400 to the distributed ledger 110 containing the non-fungible token 116 to change a list of authorized computing resources 118 or to change a pointer to the list of authorized computing resources 120. The director computer 130 may add a transaction 402 to the distributed ledger 100 containing a smart contract. The smart contract may reference one or more non-fungible tokens 116 contained in records of a transfer 112 of the non-fungible tokens 116 to accounts 114 in the distributed ledger 110. The smart contract may be a smart contract that implements a non-fungible token 116. The director computer 130 may add a transaction 402 to the distributed ledger containing a smart contract in response to an instruction 150. The director computer 130 may add a transaction 402 to the distributed ledger 110 containing a smart contract to change a list of authorized computing resources 118 or to change a pointer to the list of authorized computing resources 120.

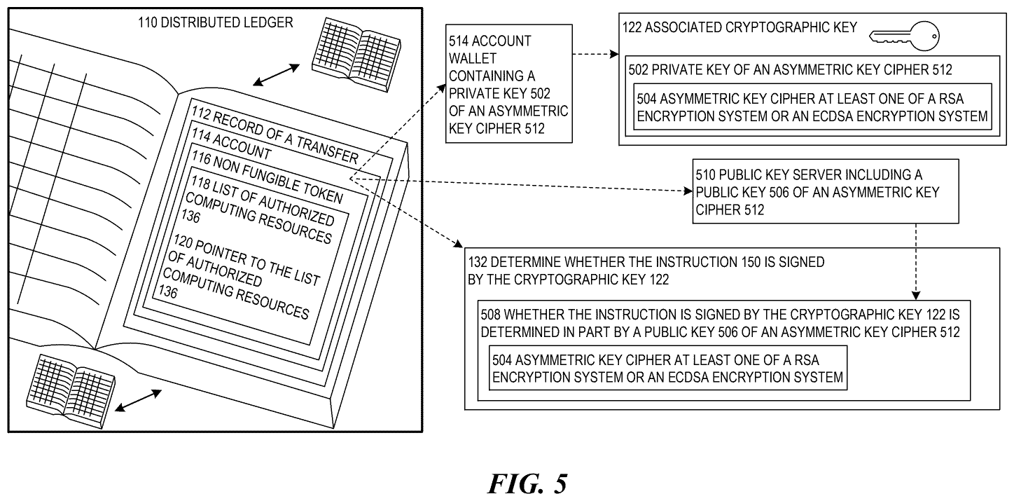

FIG. 5 is an illustration of embodiments of authentication of an instruction 150. As previously mentioned, the account 114 which the non-fungible token 116 was most recently transferred to is the possessor of the non-fungible token 116. A public and private key pair of an asymmetric key cipher may be associated with an account 114. In an embodiment, the private key is the associated cryptographic key 122. An account 114 may be associated with an account wallet 514 containing a private key 502 of an asymmetric key cipher 512. The associated cryptographic key 122 may then be the private key 502 contained in the account wallet 514. The asymmetric key cipher 512 may be at least one of one of a RSA encryption system or an ECDSA encryption system 504. The private key 502 may be used to sign an instruction 150 to perform one of said tasks 104, or for any other instruction 150 to the director computer 130. The account 114 may be identified using an identifier, with the identifier referring to the account 114 in a record of a transfer 112 of the non-fungible token 116 to the account 114 in the distributed ledger 110. The identifier may be the public key of the public/private key pair associated with the account 114 referenced in a record of a transfer 112. Alternatively, the identifier may be used to retrieve the public key from a public key server 510 including a public key 506 of an asymmetric key cipher 512, and the public key 506 may be contained with a public key certificate signed by a certification authority, and the director computer 130 may verify the authenticity of the certificate by verifying the signature on the certificate as being that of a certification authority. The public key 506 is used by the director computer 130 to determine 132 whether or not the instruction 150 is signed by the cryptographic key 122, as the associated cryptographic key 122 is the private key 502 of the public/private key pair of an asymmetric key cipher 512. The director computer 130 may determine whether 508 the instruction is signed 132 by the cryptographic key 122 in part by a public key 506 of an asymmetric key cipher 512, wherein the public key 506 and the private key 502 with is the associated cryptographic key 122 are a public/private key pair associated with an account 114. The asymmetric key cipher 512 may be at least one of a RSA encryption system or an ECDSA encryption system 504.

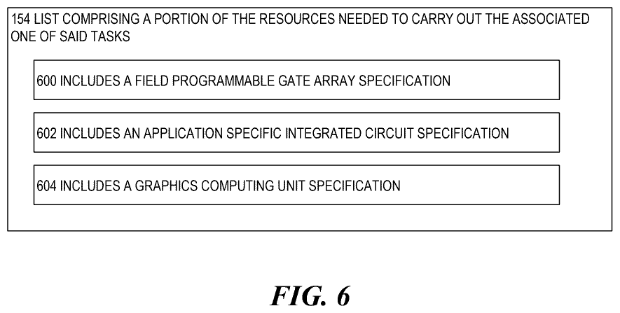

FIG. 6 is an illustration of embodiments of a list 154 comprising a portion of the resources 156 needed to carry out the associated one of said tasks 152. A list comprising a portion of the resources 156 needed to carry out the associated one of said tasks 152 may include 600 a field programmable gate array specification, and the specification of the field programmable gate array may be specified with the aforementioned methods. A list comprising a portion of the resources 156 needed to carry out the associated one of said tasks 152 may include 602 an application specific integrated circuit specification, and the specification of the application specific integrated circuit may be specified with the aforementioned methods. A list comprising a portion of the resources 156 needed to carry out the associated one of said tasks 152 may include 604 a graphics computing unit specification, and the specification of the graphics computing unit may be specified with the aforementioned methods.

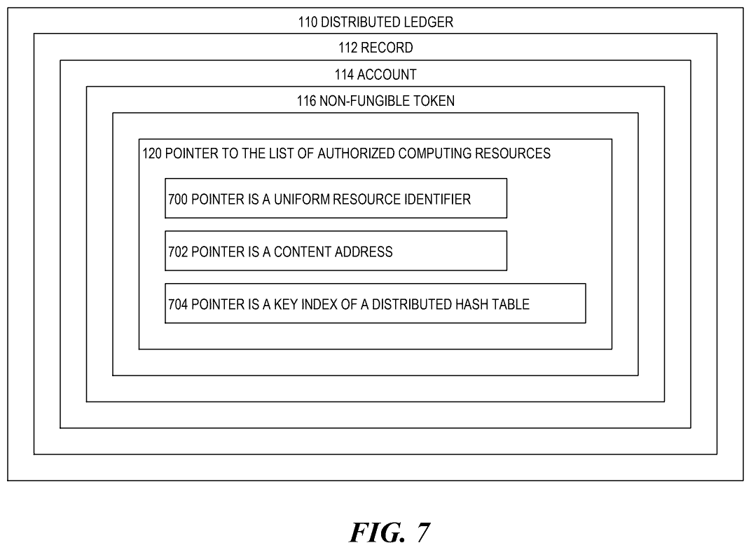

FIG. 7 is an illustration of embodiments of a pointer 120 to the list of authorized computing resources 136. A non-fungible token 116 may include a pointer 120 to the list of authorized computing resources 136, and the pointer 120 may be a uniform resources identifier 700. A uniform resource identifier may be a uniform resource locator. A pointer 120 that is a uniform resource locator may point to data that is retrievable using the hypertext transfer protocol (http), the secure hypertext transfer protocol (https), the file transfer protocol (ftp), the secure file transfer protocol (sftp), from a filesystem (file), etc. using well-known data transfer protocols or methods. A non-fungible token 116 may include a pointer 120 to the list of authorized computing resources 136, and the pointer 120 may be a content address 702. A content address may be a cryptographic hash or a message digest of a file pointed to by a content address. A content address may point to a file or object in a content addressable storage system such as git, casync, Perkeep, Arvados, or the Interplanetary File System. The content or file associated with a content address may be retrieved from a content addressable storage system based on the defined protocols of the respective storage system. A non-fungible token 116 may include a pointer 120 to the list of authorized computing resources 136, and the pointer 120 may be a key index of a distributed hash table 704. A key index in a distributed hash table may be used to retrieve the content in a data structure implemented by a distributed hash table, for example, a distributed file system, a distributed peer to peer file sharing system, and content distribution systems. Such distributed systems include Bittorrent, the Kad network, Freenet, and the Interplanetary File System. A file or data retrieved that is pointed to by a pointer 120 to a list of computing resources may be cryptographically signed by an authoritative source. The director computer 130 may verify the signature on the retrieved file or data as being signed by an authoritative source, and if the signature is not of an authoritative source, and a signature is required by the director computer 130, the retrieved file or data may be rejected as invalid as well as a non-fungible token 160 with a pointer 120 to the retrieved file or data.

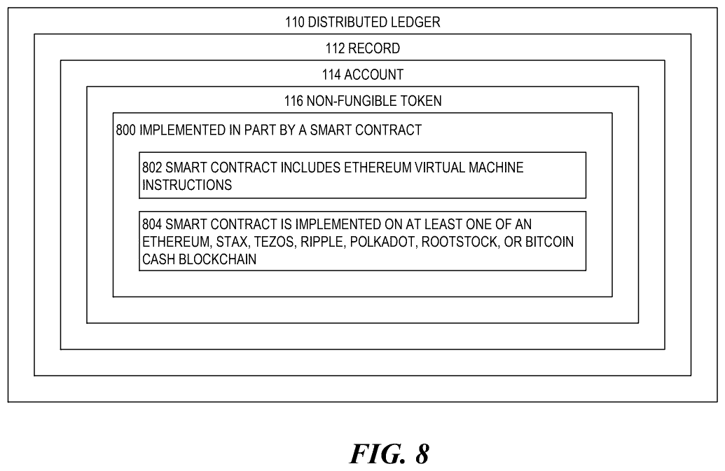

FIG. 8 is an illustration of embodiments of a non-fungible token 116. A non-fungible token 116 may be implemented in part by a smart contract 800. A smart contract may be a record on an Ethereum blockchain. A smart contract may include Ethereum Virtual Machine Instructions 802. A smart contract may be implemented on many other blockchains. A smart contract may be implemented on at least one of an Ethereum, Stax, Tezos, Ripple, Polkadot, Rootstock, or a Bitcoin Cash blockchain 804. The Ethereum Virtual Machine instructions may be used to implement smart contracts on other blockchains than the Ethereum blockchain. A smart contract may be implemented using the ERC 721 “Non Fungible Token Standard” and the EIP 1155 “Multi Token Standard” standards.

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. (canceled)

2. An apparatus comprising:
a bank of computers arranged to provide computing resources and configured to perform tasks, each one of said tasks associated with a list comprising a portion of the computing resources needed to carry out the associated one of said tasks; and
a director computer operably coupled with the bank of computers and configured to:
access a distributed ledger including a record of a transfer of a non-fungible token to an account, wherein the account has an associated cryptographic key, the non-fungible token including at least one of:
a list that includes authorized computing resources;
a pointer to the list that includes authorized computing resources; and
wherein the director computer is further configured to receive an instruction to perform one of said tasks, determine whether the instruction is signed by the cryptographic key, and if the instruction is signed by the cryptographic key, compare the list with the list of authorized computing resources to determine whether the portion of the computing resources is sufficient to perform the associated one of said tasks, and either of:
if the portion of the computing resources is sufficient, cause the associated one of said tasks to be performed on the bank of computers, and
if the instruction is not signed or if the portion of the computing resources is not sufficient, then do not cause the associated one of said tasks to be performed.

3. The apparatus of claim 2, wherein the associated one of said tasks includes instructions to perform computational operations by a graphics processing unit.

4. This apparatus of claim 2, wherein the list of authorized computing resources includes at least one of:
a number of central processing units;
a quantity of random access memory;
a quantity of nonvolatile memory;
an identifier of a computer network;
a computer within the bank of computers;
a network address on a virtual private network;
cryptographic hashes;
interval of time;
a time rate of cryptographic hashes;
a time rate;
a number of communications on a computer network;
a number of computational operations; or
an identifier of at least one of a user or a group of users.

5. The apparatus of claim 2, wherein the associated one of said tasks generates a proof-of-work, wherein the proof-of-work is generated by finding an input of a one-way function such that output of the one-way function corresponding to the input is restricted to a strict subset of a range of the one-way function.

6. The apparatus of claim 5, wherein the one-way function is a cryptographic hash function.

7. The apparatus of claim 2, wherein the bank of computers is programmed to find an input of a one-way function such that output of the one-way function corresponding to the input is restricted to a strict subset of a range of the one-way function.

8. The apparatus of claim 2, wherein the associated one of said tasks generates a proof-of-stake.

9. The apparatus of claim 2, wherein the director computer adds a transaction to the distributed ledger containing a smart contract.

10. The apparatus of claim 9, wherein the smart contract includes Ethereum Virtual Machine instructions.

11. The apparatus of claim 2, wherein the bank of computers or the list of authorized computing resources includes a cryptocurrency miner.

12. The apparatus of claim 2, wherein the non-fungible token includes the pointer, and the pointer is at least one of:
a uniform resource identifier,
a content address,
a key index of a distributed hash table.

13. The apparatus of claim 2, wherein the cryptographic key is a private key of an asymmetric key cipher.

14. A method of making the apparatus of claim 2, the method comprising:
interconnecting a computer means for determining whether an instruction is signed by a cryptographic key with a bank of computers, the interconnecting carried out after programming the bank of computers to provide computing resources to perform tasks, each one of said tasks associated with a list comprising a portion of the computing resources needed to carry out the associated one of said tasks, and after programming the computer means for determining whether an instruction is signed by a cryptographic key and:
if the instruction is signed by the cryptographic key, comparing the list with the list of authorized computing resources to determine whether the portion of the computing resources is sufficient to perform the associated one of said tasks, and if the portion of the computing resources is sufficient, cause the associated one of said tasks to be performed on the bank of computers, and if the instruction is not signed or if the portion of the computing resources is not sufficient, then do not cause the associated one of said tasks to be performed.

15. A method of using the apparatus of claim 2, the method comprising:
controlling a computer means for determining whether an instruction is signed by a cryptographic key with a bank of computers arranged to provide computing resources and configured to perform tasks, each one of said tasks associated with a list comprising a portion of the computing resources needed to carry out the associated one of said tasks, and:
if the instruction is signed by the cryptographic key, comparing the list with the list of authorized computing resources to determine whether the portion of the computing resources is sufficient to perform the associated one of said tasks, and if the portion of the computing resources is sufficient, cause the associated one of said tasks to be performed on the bank of computers, and if the instruction is not signed or if the portion of the computing resources is not sufficient, then do not cause the associated one of said tasks to be performed.

16. A process comprising:
interconnecting a director computer and a bank of computers, wherein the interconnecting is carried out after programming the bank of computers to provide computing resources to perform tasks, each one of said tasks associated with a list comprising a portion of the computing resources needed to carry out the associated one of said tasks;
accessing, by the director computer, a distributed ledger including a record of a transfer of a non-fungible token to an account, wherein the account has an associated cryptographic key, the non-fungible token including at least one of:
a list that includes authorized computing resources;
a pointer to the list that includes authorized computing resources; and
receiving, by the director computer, an instruction to perform one of said tasks; and
determining, by the director computer, whether the instruction is signed by the cryptographic key; and
performing either:
if the instruction is signed by the cryptographic key, compare the list with the list of authorized computing resources to determine whether the portion of the computing resources is sufficient to perform the associated one of said tasks, wherein if the portion of the computing resources is sufficient, cause the associated one of said tasks to be performed on the bank of computers; or
if the instruction is not signed or if the portion of the computing resources is not sufficient, then do not cause the associated one of said tasks to be performed.

17. The process of claim 16, wherein the associated one of said tasks includes instructions to perform computational operations by a graphics processing unit.

18. This process of claim 16, wherein the list of authorized computing resources includes at least one of:
a number of central processing units;
a quantity of random access memory;
a quantity of nonvolatile memory;
an identifier of a computer network;
a computer within the bank of computers;
a network address on a virtual private network;
cryptographic hashes;
interval of time;
a time rate of cryptographic hashes;
a time rate;
a number of communications on a computer network;
a number of computational operations; or
an identifier of at least one of a user or a group of users.

19. The process of claim 16, wherein the associated one of said tasks generates a proof-of-work, wherein the proof-of-work is generated by finding an input of a one-way function such that output of the one-way function corresponding to the input is restricted to a strict subset of a range of the one-way function.

20. The process of claim 19, wherein the one-way function is a cryptographic hash function.

21. The process of claim 16, wherein the bank of computers is programmed to find an input of a one-way function such that output of the one-way function corresponding to the input is restricted to a strict subset of a range of the one-way function.

22. The process of claim 16, wherein the associated one of said tasks generates a proof-of-stake.

23. The process of claim 16, wherein the director computer adds a transaction to the distributed ledger containing a smart contract.

24. The process of claim 23, wherein the smart contract includes Ethereum Virtual Machine instructions.

25. The process of claim 16, wherein the bank of computers or the list of authorized computing resources includes a cryptocurrency miner.

26. The process of claim 16, wherein the non-fungible token includes the pointer, and the pointer is at least one of:
a uniform resource identifier,
a content address,
a key index of a distributed hash table.

27. The process of claim 16, wherein the cryptographic key is a private key of an asymmetric key cipher.

28. A process comprising:
controlling director computer interaction with a bank of computers arranged to provide computing resources and configured to perform tasks, each one of said tasks associated with a list comprising a portion of the computing resources needed to carry out the associated one of said tasks, such that the director computer:
accessing a distributed ledger including a record of a transfer of a non-fungible token to an account, wherein the account has an associated cryptographic key, the non-fungible token including at least one of:
a list that includes authorized computing resources;
a pointer to the list that includes authorized computing resources; and
receives an instruction to perform one of said tasks; and
determines whether the instruction is signed by the cryptographic key, and:
if the instruction is signed by the cryptographic key, compare the list with the list of authorized computing resources to determine whether the portion of the computing resources is sufficient to perform the associated one of said tasks; and
if the portion of the computing resources is sufficient, cause the associated one of said tasks to be performed on the bank of computers; and
if the instruction is not signed or if the portion of the computing resources is not sufficient, then do not cause the associated one of said tasks to be performed.

29. The process of claim 28, wherein the associated one of said tasks includes instructions to perform computational operations by a graphics processing unit.

30. The process of claim 28, wherein the list of authorized computing resources includes at least one of:
a number of central processing units;
a quantity of random access memory;
a quantity of nonvolatile memory;
an identifier of a computer network;
a computer within the bank of computers;
a network address on a virtual private network;
cryptographic hashes;
interval of time;
a time rate of cryptographic hashes;
a time rate;
a number of communications on a computer network;
a number of computational operations; or
an identifier of at least one of a user or a group of users.

31. The process of claim 28, wherein the associated one of said tasks generates a proof-of-work, wherein the proof-of-work is generated by finding an input of a one-way function such that output of the one-way function corresponding to the input is restricted to a strict subset of a range of the one-way function.

32. The process of claim 31, wherein the one-way function is a cryptographic hash function.

33. The process of claim 28, wherein the bank of computers is programmed to find an input of a one-way function such that output of the one-way function corresponding to the input is restricted to a strict subset of a range of the one-way function.

34. The process of claim 28, wherein the associated one of said tasks generates a proof-of-stake.

35. The process of claim 28, wherein the director computer adds a transaction to the distributed ledger containing a smart contract.

36. The process of claim 35, wherein the smart contract includes Ethereum Virtual Machine instructions.

37. The process of claim 28, wherein the bank of computers or the list of authorized computing resources includes a cryptocurrency miner.

38. The process of claim 28, wherein the non-fungible token includes the pointer, and the pointer is at least one of:
a uniform resource identifier,
a content address,
a key index of a distributed hash table.

39. The process of claim 28, wherein the cryptographic key is a private key of an asymmetric key cipher.
